(19) United States
(12) Patent Application Publication
(10) Pub. No.: US 2013/0026333 A1
(43) Pub. Date: Jan. 31, 2013

(54) MOUNTING APPARATUS FOR FAN

(71) Applicant: ZE-YUN WU, Shenzhen City (CN)

(72) Inventor: ZE-YUN WU, Shenzhen City (CN)

(73) Assignees: HON HAI PRECISION INDUSTRY CO., LTD., Tu-Cheng (TW); Hong Fu Jin Precision Industry (ShenZhen) Co., Ltd, Shenzhen City (CN)

(21) Appl. No.: 13/407,773

(22) Filed: Feb. 29, 2012

(30) Foreign Application Priority Data
Jul. 29, 2011 (CN) 201110215687.7

(51) Int. Cl. F16M 11/10

(52) U.S. Cl. 248/674

(57) ABSTRACT

A mounting apparatus is used to position a fan in place and includes a base, a support arm extending up from the base, an angle adjusting member including a first rail rotatably coupled to the support arm, and a mounting member including a second rail slidably coupled to the first rail. The fan is fixed to an end of the second rail. The position of the fan is adjustable in respect of height and can also be adjusted to move closer to or away from a heat-generating component as required.

### BACKGROUND

1. Technical Field

The present disclosure relates to an apparatus for mounting a fan.

2. Description of Related Art

In testing of an electronic device, such as a motherboard, a fan may be required for heat-dissipation. The fan may be fixed in a place so as to align with a heat generating component, such as a processor, of the electronic device. However, it is not at all convenient to move the fan and set it up repeatedly when heat-dissipation is required in different places or from different angles.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a mounting apparatus and a fan, wherein the mounting apparatus includes a base, two support arms, an angle adjusting member, two sliding blocks, and a mounting member.

FIG. 2 is an enlarged view of one of the sliding blocks of FIG. 1.

FIG. 3 is an isometric, partially cut-away view of the mounting member of FIG. 1, but viewed from a different perspective.

FIGS. 4-6 are assembled, isometric views of the mounting apparatus and fan shown in FIG. 1, but showing different states.

### DETAILED DESCRIPTION OF THE DESCRIPTION

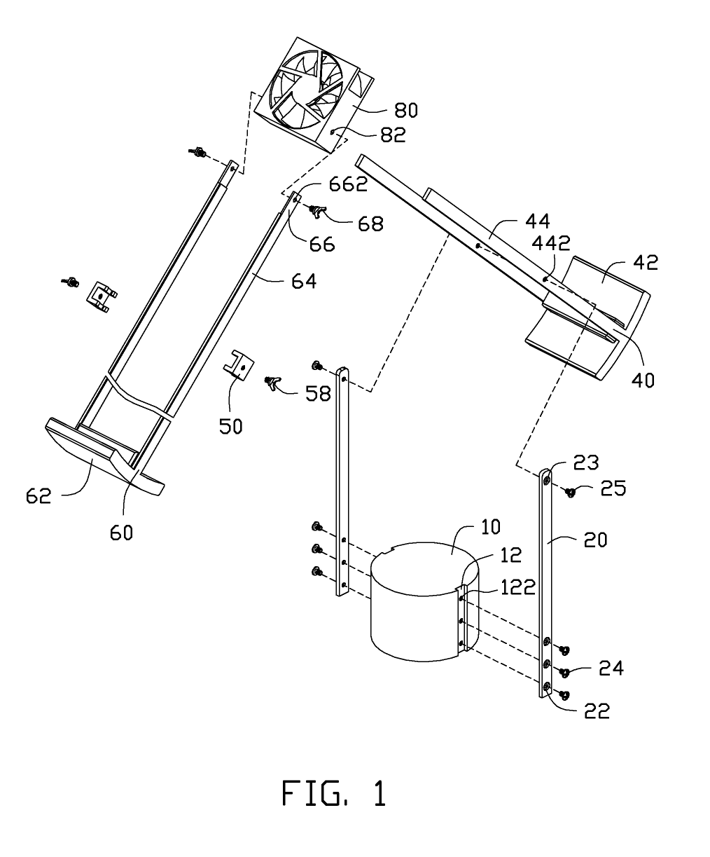

Referring to FIG. 1, an embodiment of a mounting apparatus is used to hold a fan 80 at a desired position. The fan 80 is substantially rectangular with two threaded holes 82 respectively defined in opposite sides of the fan 80. The mounting apparatus includes a base 10, two support arms 20, an angle adjusting member 40, two sliding blocks 50, and a mounting member 60.

The base 10 is cylindrical, and defines opposite recesses 12 in the circumference of the base 10. The recesses 12 are vertical. Three fastening holes 122 are defined in a bottom of each of the recesses 12.

Each of the support arms 20 defines three fixing holes 22 adjacent to a bottom end of the support arming 20, and a pivot hole 23 adjacent to a top end of the support arm 20.

The angle adjusting member 40 includes two parallel first rails 44 and a balance block 42 connected between corresponding ends of the first rails 44. A screw hole 442 is defined in a middle of each of the first rails 44.

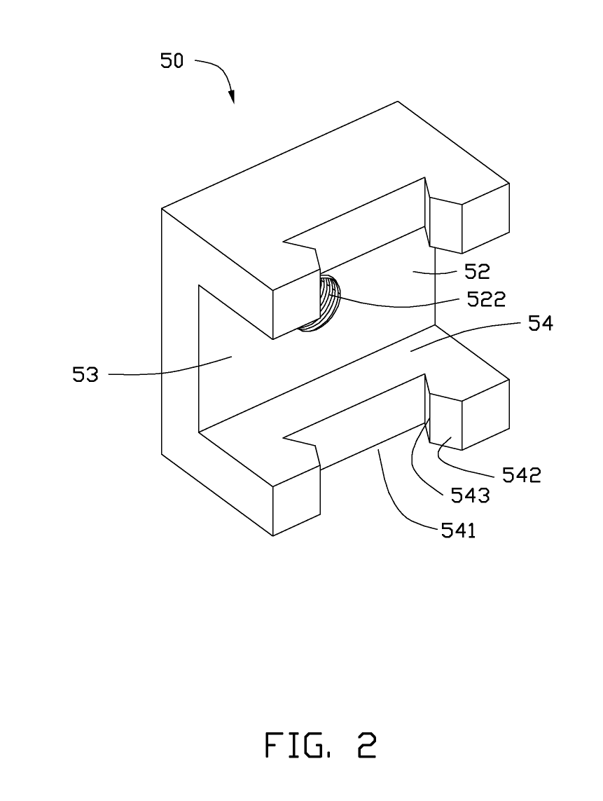

Referring to FIG. 2, each of the sliding blocks 50 includes a rectangular base wall 52 and two sidewalls 54. The base 52 and the sidewalls 54 bound a holding groove 53. The base wall 52 defines a threaded hole 522. Each of the sidewalls 54 defines a dovetailed groove 541 so the two dovetailed grooves 541 are in alignment. The dovetailed groove 541 does not extend down to the base wall 52. Two opposite slanted engagement portions 542 are formed on the sidewall 54, at opposite sides of the opening of the groove 541. Therefore, each of opposite sidewalls bounding the dovetailed groove 541 and a corresponding engagement portion 542 are connected together to form a substantially V-shaped sliding portion 543.

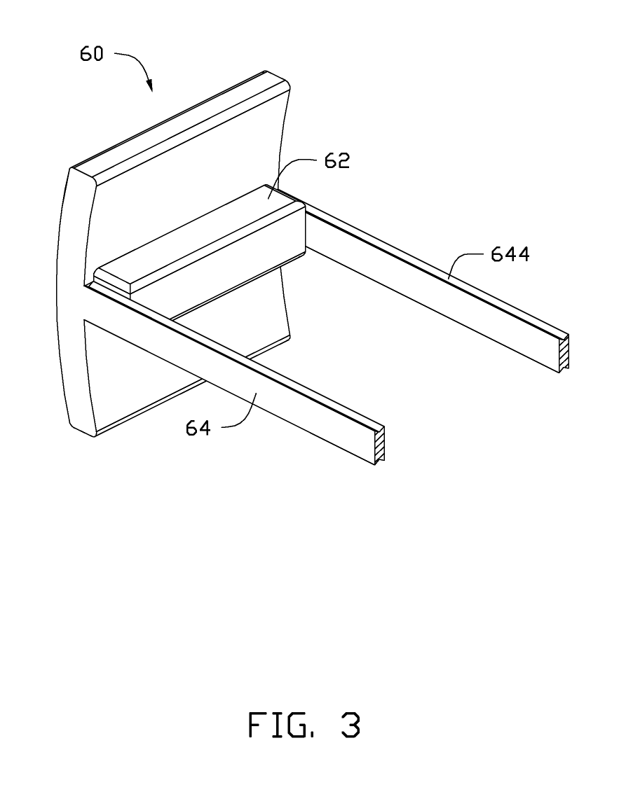

Referring to FIG. 3, the mounting member 60 includes two parallel second rails 64, a balance block 62 connected between first ends of the second rails 64, and two mounting portions 66 respectively extending from second ends of the second rails 64 farthest away from the balance block 62. Two substantially V-shaped engagement grooves 644 are longitudinally defined in opposite side surfaces of each of the second rails 64. Each of the mounting portions 66 defines a positioning hole 662.

Referring to FIGS. 1-4, in assembly, the support arms 20 are received in the recesses 12 of the base 10. The fixing holes 22 of each of the support arms 20 are aligned with the fastening holes 122 in the recess 12. Six screws 24 extend through the fixing holes 22 and engage in the fastening holes 122, to fix the support arms 20 to the base 10. A screw 25 extends through each pivot hole 23 and engages in the screw hole 442 of the first rail 44 of the angle adjusting member 40, to connect the angle adjusting member 40 to the support arms 20. The sliding blocks 50 are slidably sleeved on the first rails 44 of the angle adjusting member 40 through the holding grooves 53. The second rails 64 of the mounting members 60 are slidably sleeved by the sliding blocks 50, through the grooves 541. The sliding portions 543 are slidably received in the engagement grooves 644. Two fasteners 58 are engaged in the threaded holes 522 of the sliding blocks. The fasteners 58 can be tightened against the first rail 44 and thus apply pressure against the second rails 64, thereby positioning and securing the mounting member 60 on the angle adjusting member 40. The fan 80 is sandwiched between the mounting portions 66 of mounting member 60. Two fasteners 68 extend through the positioning holes 662 and are fixed in the threaded holes 82 of the fan 80 to fix and secure the fan 80 to the mounting member 60.

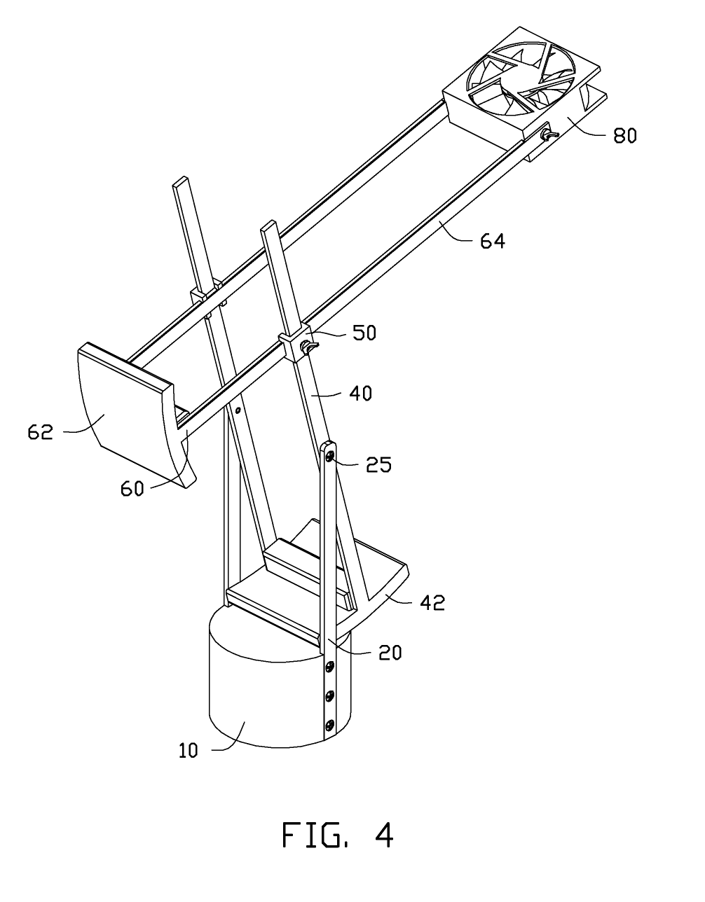

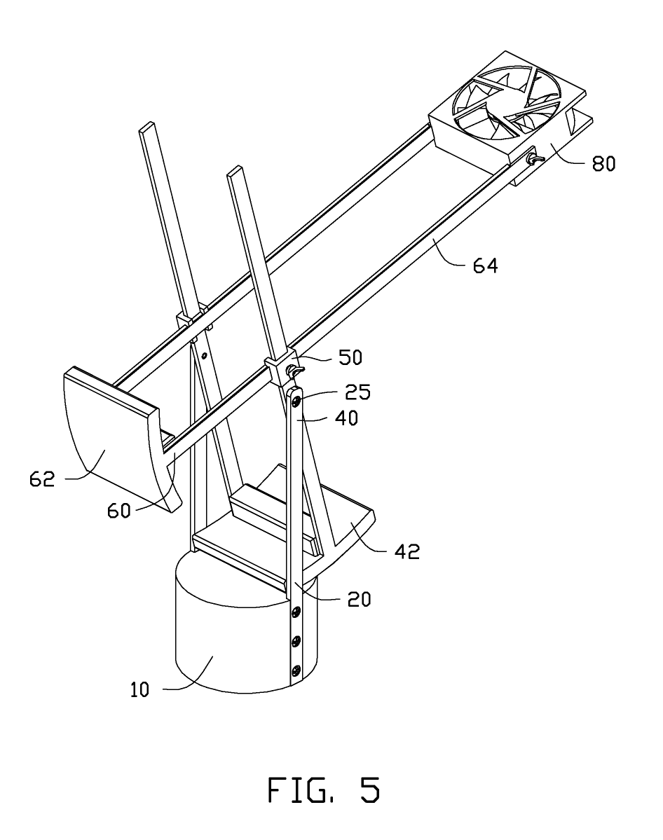

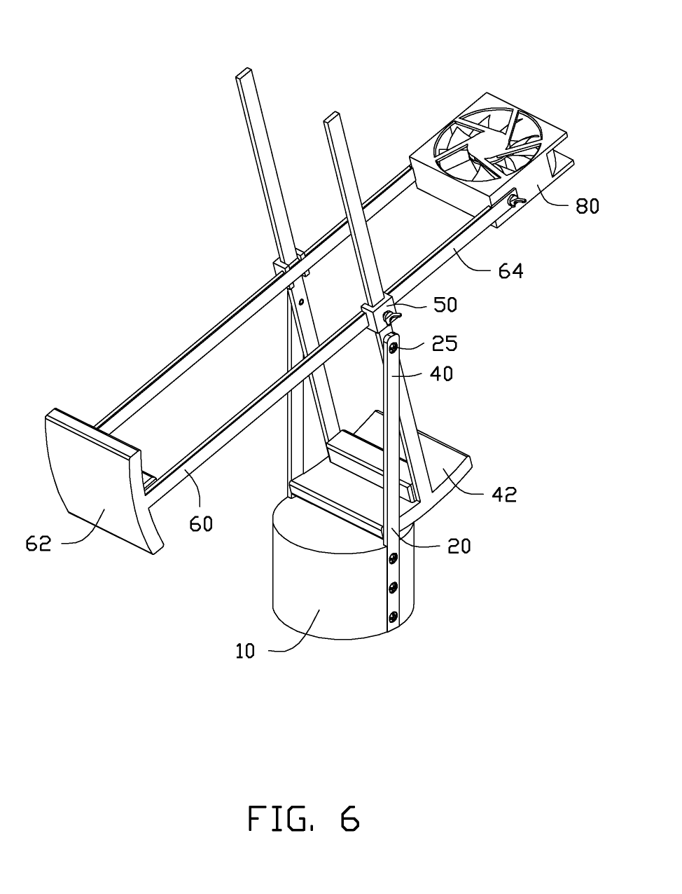

Referring FIGS. 4 to 6, to relocate the fan 80, the fastener 58 is loosened. The second rails 64 is then able to slide relative to the sliding blocks 50. The sliding blocks 50 are also then free to slide along the first rails 44. Therefore, the position of the fan 80 can be adjusted without moving the base 10. To adjust an airflow generated by the fan 80, the screws 25 are slightly loosened. The first rails 44 of the angle adjusting member 40 pivot about the screws 25. Therefore, the sliding blocks 50, the mounting member 60, and the fan 80 can be rotated together to adjust as well as redirect the airflow generated by the fan 80.

It is to be understood, however, that even though numerous characteristics and advantages of the present disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A mounting apparatus for a fan, comprising:
a base;
a support arm extending up from the base;
an angle adjusting member comprising a first rail rotatably coupled to the support arm; and
a mounting member comprising a second rail slidably coupled to the first rail of the angle adjusting member, and a mounting portion formed on an end of the second rail to fix the fan.

2. The mounting apparatus of claim 1, further comprising a sliding block slidably coupled to the first rail of the angle adjusting member, wherein the second rail of the mounting member is slidably coupled to the sliding block.

3. The mounting apparatus of claim 2, wherein the sliding block comprises a base wall and two sidewalls respectively extending from opposite sides of the base wall, the base wall and the sidewalls together bound a holding groove, two dovetailed grooves are respectively defined in the sidewalls and aligning with each other, the first rail of the angle adjusting member is slidably engaged in the holding groove, the second rail is slidably engaged in the dovetailed grooves of the sidewalls.

4. The mounting apparatus of claim 3, wherein opposite sides of the second rail longitudinally define two engagement grooves, two opposite slanted engagement portions are formed on each sidewall of the sliding block at opposite sides of the corresponding dovetailed groove, each of opposite sidewalls bounding the dovetailed groove and a corresponding engagement portion forms a substantially V-shaped sliding portion, to slidably engaged in a corresponding engagement groove.

5. The mounting apparatus of claim 4, wherein the first rail is arranged between the base wall of the sliding block, the base wall defines a threaded hole to allow a fastener to engage in the threaded hole and further abut against the first rail toward the second rail, to position the first and second rails.

6. The mounting apparatus of claim 1, wherein the mounting member comprises a balance block fixed to an end of the second rail far away from the fan.

7. A mounting apparatus for a fan, comprising:
a base;
two support arms extending up from the base;
an angle adjusting member comprising two first rails respectively rotatably coupled to the support arms; and
a mounting member comprising two second rails respectively slidably coupled to the first rails of the angle adjusting member, and two mounting portions formed on corresponding ends of the second rails and respectively fixed to opposite sides of the fan.

8. The mounting apparatus of claim 7, wherein the mounting member further comprises a balance block fixed to ends of the second rails far away from the fan.

9. The mounting apparatus of claim 7, further comprising two sliding blocks slidably coupled to the first rails of the angle adjusting member, wherein the second rails of the mounting member are slidably coupled to the corresponding sliding blocks.

10. The mounting apparatus of claim 7, wherein the base is cylindrical, and defines opposite recesses in the circumference of the base, the support arms are respectively engaged in the recesses of the base.
